(19) United States
(12) Patent Application Publication
(10) Pub. No.: US 2013/0037640 A1
(43) Pub. Date: Feb. 14, 2013

(54) PROTECTION BLOCK FOR THE ROTOR OF A MATERIAL GRINDER

(71) Applicant: Jean-Luc Mossotti, Septemes-les-Vallons (FR)

(72) Inventor: Jean-Luc Mossotti, Septemes-les-Vallons (FR)

(21) Appl. No.: 13/577,376

(22) PCT Filed: Feb. 3, 2011
(86) PCT No.: PCT/FR2011/000068

§ 371 Date: Oct. 31, 2012

(30) Foreign Application Priority Data
Feb. 5, 2010 (FR) 1000458

(51) Int. Cl. B02C 13/26

(52) U.S. Cl. 241/191

(57) ABSTRACT

The invention is an improvement on existing crushers that allows a significant reduction in the operating cost of said crushers while allowing, among other things, a substantial economy in the material from which the rotor protection elements of said crushers are manufactured.

A subject of the invention is a protection block for a rotor of a material crusher, particularly the rotors of scrap metal crushers, comprising
a first piece or armouring plate (2.2) itself comprising, detachably or non-detachably fixed on its inner face, a first fixing means (2.3), and
a second piece, independent of the first piece, forming a second fixing means (2.4).

The invention relates to the field of machine-tools of the industrial crusher type and particularly, non-limitatively, scrap metal crushers. The invention is in fact an improvement on existing crushers which allows a significant decrease in the operating cost of said crushers by allowing inter alia a substantial saving in the material from which the protective elements of said rotors are made. This improvement moreover allows easier handling of the interchangeable pieces constituting said protective elements of said rotors.

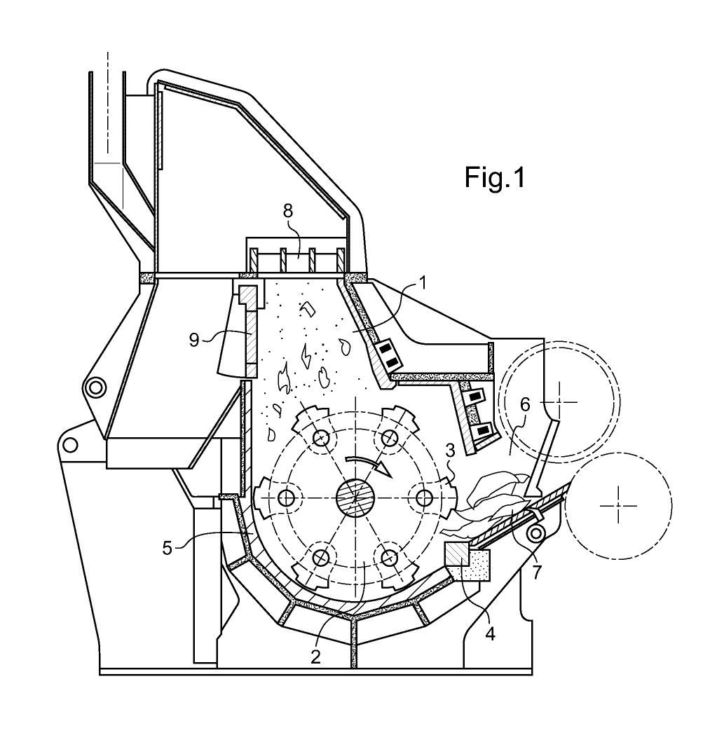

Generally, existing crushers (see FIG. 1), particularly scrap metal crushers, are constituted by an inner main casing (1) within which a rotor (2) turns, driven by an electric motor. Said rotor is equipped on its periphery with hammers (3) suitable for cooperating with the edge of an anvil (4) secured to the casing. The casing has an inner wall covered with resistant armouring plates (5).

The material to be crushed (7) is introduced into the casing through an opening (6) generally situated close to the rotor. In general the material to be crushed is conveyed to the crusher by a conveyor belt which feeds the crusher in a continuous fashion.

The material to be crushed, carried along by the rotation of the rotor, is crushed between the hammers of the rotor and an anvil. The crushed fragments of material are then dragged tangentially on the wall of the casing to the part opposite the feed opening to then be thrown into the upper part of the casing which comprises a grid (8) arranged above the rotor, the mesh dimension of which is defined to determine the particle size of the product at the exit: only the crushed material fragments which have reached the desired particle size, defined by the mesh dimensions of the grid, can be ejected.

Said rotors are generally constituted by a series of discs (which can range up to 13 for example) mounted in parallel on one or more shaft(s). The hammers (variable in number depending on the size of the rotor and the crusher, generally 12 to 26) that will allow the materials to be crushed are fixed to this assembly. But the hammers do not cover the entire edge of the discs constituting the rotor. It is therefore necessary to provide an armouring in order to protect the discs and particularly their edge. This is achieved by the addition of a set of protection blocks constituting an armouring (in the general meaning of the term) that are secured to the rotor and positioned on its periphery. Due to the presence of this armouring, the discs and their edge are no longer in contact with the material to be crushed. It is therefore understood that the armouring of the rotor is constituted by several pieces (the protection blocks or “caps”) constituting an assembly. In the present text these pieces are called “protection block” or “armouring block”.

The invention relates to said protection or armouring blocks.

To date said protection blocks are made as a single unit, of any material compatible with the function, advantageously steel, securely mounted on the rotor, each comprising an armouring plate in the form of a rectangular metal plate, of a given thickness, shaped as an arc of circle along its greater length and the radius of which is identical to the outer radius of the discs of the rotor that it must protect, and a fixing means of said armouring plate to said discs of the rotor, said fixing means being secured in a non-detachable manner to said armouring plate. Each protection block (armouring plate and fixing means) can be a single cast piece or two pieces bonded together by welding.

These unitary pieces are heavy, which makes them difficult to handle, and are costly since they involve a large quantity of raw material for their manufacture. By way of example, for a crusher the rotor of which has a diameter of 1350 mm, such a piece can weigh from 80 to 120 Kg or even sometimes much more.

Moreover, due to the method of operation of the crushers in which these pieces are used, the armouring plate wears during the crushing of the materials in the crusher. Their regular replacement is therefore a necessity. Apart from the weight and due to their unitary design it is therefore the whole of the unitary piece, i.e. the entire protection block, that must be replaced once the armouring piece is worn. Thus, it will be understood that the whole of the protection block is scrapped, while a large part of said piece, mainly that constituting the fixing means to the rotor, is intact. Therefore, each time the armouring is changed, a large quantity of raw material is thus disposed of unnecessarily.

Document U.S. Pat. No. 5,169,077 A (Stelk John C (US)) discloses detachable ends for the hammers at the end of each arm of a hammermill. It describes a protection cap constituted by a part performing the function of armouring and a fixing means, said fixing means being secured to said armouring. In this configuration, replacing the armouring requires per se replacement of the fixing means secured thereto when the latter is not worn.

The aim of the invention is to make the handling of said protection blocks more economic and easier. After extensive testing the Applicant found that it is possible to use protection blocks comprising two separate pieces; an armouring plate and a fixing means of said armouring plate to said discs of the rotor, these 2 pieces being secured together only at the time of their use. The armouring plate is the piece in contact with the material to be crushed, and is damaged thereby during the use of the crusher. As the fixing means are not in contact with the material to be crushed, they are not significantly damaged and can be reused after being detached from the damaged armouring plate and can then be fixed to a fresh armouring plate. Thus according to the invention said protection blocks are no longer unitary pieces.

The Applicant has moreover found that the strength of said protection blocks is not affected if said blocs are no longer in the form of unitary pieces but constituted by two separate pieces secured together at the time of their use.

Thus a subject of the invention is a protection block for a rotor of a material crusher, particularly the rotors of scrap metal crushers, comprising
a first piece or armouring plate itself comprising, detachably or non-detachably fixed on its inner face, a first fixing means, and
a second piece, independent of the first piece, forming a second fixing means.

According to the invention, said first fixing means is intended to secure said armouring plate to the second fixing means which is itself intended to secure said armouring plate to the rotor of the crusher.

According to the invention, said armouring plate can have, in its orthogonal projection, any shape compatible with its function, preferably that of a parallelogram such as for example a rectangle, a square, a diamond. Advantageously according to the invention, the armouring plate can have a rectangular shape.

Also according to the invention the armouring plate can have, in its lateral projection, any shape compatible with its function, particularly compatible with the shape of the rotor that it must protect. Advantageously the armouring plate will have along its greatest length the shape of an arc of a circle the radius of which is identical to the outer radius of the discs of the rotor that it must protect.

Also according to the invention the armouring plate can have any thickness compatible with its function. A person skilled in the art will have no difficulty in adapting said thickness to his requirements. Advantageously according to the invention the armouring plate can have a thickness comprised between 10 mm and 100 mm, preferably between 40 mm and 60 mm.

According to the invention, the first and second fixing means can adopt all forms compatible with their functions.

Thus, according to a first embodiment of the invention, said first fixing means can be in four separate pieces, positioned in pairs in order to be secured, detachably or non-detachably, to said armouring plate at each end thereof.

According to the invention, at each end of said armouring plate, two of said pieces can be positioned parallel to each other along the longitudinal axis of said armouring plate, such that they can provide between them a space sufficient to receive said second fixing means.

According to this embodiment of the invention, each of said pieces forming said first fixing means can have any shape compatible with its function. Advantageously in a side view these pieces can adopt a shape substantially equal to that of a right angled triangle the hypotenuse of which can have a curvature allowing it to be adapted to the curvature of the inner face of said armouring plate. However these pieces can optionally also have a substantially square or rectangular shape, with the proviso that one of their sides has a curvature allowing it to be adapted to the curvature of the inner face of said armouring plate.

Also according to the invention each of said pieces will comprise at least one hole intended to be positioned level with an identical hole provided in said second fixing means and intended to receive a shaft capable of securing the armouring plate/second fixing means assembly.

Also according to this embodiment of the invention, the armouring plate/first fixing means assembly can constitute one and the same piece cast en bloc or also a single piece, the pieces forming the first fixing means capable of being welded onto the inner face of said armouring plate.

According to a variant of the invention the pieces forming said first fixing means can be secured on the armouring plate in a reversible manner by any suitable means, such as for example screwing, bolting, interlocking or also mounting on a slide.

According to another variant of the invention, the pieces forming said first fixing means can be fixed onto the armouring plate in an irreversible manner, for example by means of welds.

Even more preferably, the armouring plate and the pieces forming said first fixing means are cast (forged) in a single piece, which has the advantage of ensuring better resistance of the assembly to the impacts produced during crushing.

Also according to this embodiment the pieces forming the first fixing means can be of any material compatible with their function, advantageously these pieces are of the same material as the armouring plate.

Similarly these pieces can have any thickness compatible with their function. However, inasmuch as once secured to the second fixing means the assembly constituted (at each end of the armouring plate) by the two pieces of the first fixing means and the piece of the second fixing means must be capable of insertion in the space provided between two discs of the rotor of the crusher; it being easily understood that a person skilled in the art will adjust the thickness both of the pieces of the first fixing means and of the second fixing means so that the assembly has a thickness at least equal to the dimension of said space, while retaining for each of the pieces a thickness compatible with the strength that it must offer. Advantageously according to the invention each of the pieces of the first fixing means and the second fixing means can have an identical thickness corresponding to one third of the dimension of the space comprised between two discs of the rotor.

According to this first embodiment of the invention, the second fixing means can adopt all forms compatible with its function, with the proviso that on the one hand it can be secured to said armouring plate and on the other hand it can be secured to said rotor.

Advantageously the second fixing means will be substantially diamond-shaped in side view comprising in its widest portion a first hole passing through it perpendicularly from one side to the other, said first hole being capable of receiving a shaft allowing said second fixing means to be secured to said discs of said rotor of the crusher.

Inasmuch as said second fixing means must also be capable of being secured to said armouring plate, it can moreover comprise at each of these ends at least one second hole passing through it perpendicularly from one side to the other, said second hole being capable of receiving a shaft allowing said second fixing means to be secured to said armouring plate through said second fixing means.

According to the invention a person skilled in the art will have no difficulty in adapting the diameter of each of the holes as a function of the diameter of the shaft that it is desired to use; the diameter of said shaft must be sufficient to offer adequate strength.

According to the invention, the thickness of said second fixing means can be configured such that that it can on the one hand be inserted between two discs of the rotor of the crusher; its thickness, at least over a portion of its length; must therefore be compatible with the dimensions of the inner space separating two discs of the rotor so that the lateral play of said fixing means between the two discs is minimal. But at the same time said second fixing means must be capable of receiving the first fixing means at each of its ends in order to secure the armouring plate to the second fixing means. Thus, in this embodiment of the invention, at each of its ends said second fixing means will have a thickness at least equal to the space provided between the two pieces forming the first fixing means.

Thus according to the invention said second fixing means can have in its median portion, around said first hole, a thickness substantially equal to the distance separating two discs of the rotor between which it must be interposed and at the level of these ends a lesser thickness in order to provide between itself and the discs of the rotor spaces that are sufficient to allow said first fixing means to also be inserted between the two discs of the rotor. Advantageously according to the invention the thickness of said second fixing means at these ends can correspond to one third of the dimension of the space situated between two discs.

Even more advantageously according to this first embodiment of the invention each of the pieces of the first fixing means and the second fixing means can have an identical thickness corresponding to one third of the dimension of the space comprised between two discs of said rotor between which they must be inserted.

According to a second embodiment of the invention, said first fixing means and said second fixing means can have a configuration that is the reverse of that of the first embodiment.

Thus contrary to the first embodiment in which said armouring plate bears on its inner face a double pair of pieces for forming the first fixing means and the second fixing means is in a single piece; in the second embodiment of the invention, the armouring plate can bear only a first fixing means formed of two pieces, advantageously identical to those forming the first fixing means described in the first embodiment of the invention, each capable of being positioned at one of the ends of the inner face of the armouring plate and the second fixing means can be formed by the combination of two pieces, advantageously identical to those forming the second fixing means described in the first embodiment of the invention, such that that positioned parallel to each other these two pieces will provide between them a space intended to receive the pieces forming the first fixing means.

Advantageously, without being mandatory, the two pieces forming said second fixing means can be joined in the middle by a spacer setting the dimension of the space between said two pieces. This spacer may or may not be secured non-detachably to said two pieces. It can moreover be envisaged that the spacer is secured non-detachably to only one of the two pieces. Thus the second fixing means can be formed of one unitary unit, or two separate pieces or three separate pieces.

According to this second embodiment, when the spacer is non-detachably secured to the two pieces then the second fixing means can be a unitary cast or welded piece, and when the spacer is non-detachably secured to one of the two pieces then this assembly can be a unitary welded or cast piece.

It will be easily understood that in this second embodiment the pieces forming the first and second fixing means can be the same as those forming the first and second fixing means of the first embodiment of the invention, with the understanding that that when two pairs of pieces were used to form the first fixing means in the first embodiment, there are only two pieces in the second embodiment of the invention and that when only one piece was used to form the second fixing means in the first embodiment, there are two in the second embodiment of the invention.

It will be easily understood that in this embodiment during the assembly of the armouring plate and the second fixing means the pieces forming the first fixing means will be fitted between the two pieces forming the second fixing means. For this reason according to this second embodiment the thickness of the piece forming the first embodiment will be at least equal to the dimension of the space provided between the two pieces of the second fixing means.

Still according to this second embodiment of the invention the armouring plate through the first fixing means and the second fixing means can be secured via shafts positioned perpendicularly to said first and second means in the holes provided for this purpose in said fixing means. Similarly, the armouring plate and second fixing means assembly can be secured to the rotor by means of a shaft passing perpendicularly through said pieces forming said second fixing means in the hole provided for this purpose in its centre.

According to yet another embodiment of the invention, the armouring plate and the second fixing means can be secured by means of a simple mortise/tenon joint. Thus it is possible that the armouring plate comprises on its inner face at least one mortise, of any shape possible, and that the second fixing means comprises on its edge coming into contact with the armouring plate at least one tenon having a profile corresponding to the profile of said mortise. Advantageously said mortise and said tenon will be configured at the time of manufacture of said pieces, for example during the casting thereof. In this third embodiment, the assembly of the armouring plate and the second fixing means can be done by simply sliding one piece onto the other so that the tenon adopts its position in the mortise.

Regardless of the embodiment of the invention, said armouring plate, the first and second fixing means can be made from any material suitable for the use for which they are intended. According to the invention, they can be made from the same material or different materials. Advantageously these pieces will be of the same material.

According to the invention, said armouring plate, the first and second fixing means can be made of cast manganese steel or chrome vanadium steel or antiabrasion welded machine steel of the HARDOX® (Swedish Steel, Sweden), CREUSABO® or equivalent types (ARCELOR, France).

According to the invention, the holes intended to receive the pins can adopt any known shape. They can have a circular, square, rectangular, triangular, or elliptic shape. Preferably the holes have a circular shape.

According to the invention, the dimensions of said holes are defined by the size of the shafts or pins to be used. A person skilled in the art will without difficulty be able to adapt said dimensions to the intended purpose.

A subject of the invention is also protective armouring of the rotor of a material crusher, preferably scrap metal crushers, comprising at least one protection block according to the invention.

A further subject of the invention is the use of at least one protection block according to the invention for producing protective armouring for the rotor of a material crusher, preferably scrap metal crushers.

Of course, the invention can be adapted to any existing rotor of a crusher; the latter can have variable dimensions. It will thus be understood that according to the dimensions of the rotor, the number of protection blocks can be variable and said blocks can adopt any required dimensions. A person skilled in the art will without difficulty be able to adapt the number and dimensions of said blocks to the dimensions of the rotor used.

A subject of the invention is also a material crusher, particularly a scrap metal crusher, comprising a protective armouring of the rotor comprising at least one protection block according to the invention.

In particular, the invention relates to a material crusher, particularly a scrap metal crusher, comprising an inner main casing, at least one rotor, hammers on said rotor, at least one anvil, a casing base which is closed and covered with resistant armouring plates, a feed opening, an ejection grid provided above the rotor and an ejection door, said rotor comprising the protection blocks such as described previously.

Advantageously the material crusher according to the invention is a crusher such as described in European Patent Application EP2012924.

Objects, characteristics and advantages of the invention will become apparent from the description which follows, given as a non-limitative illustration, with reference to the attached drawings in which:

FIG. 1 represents a cross-section of a conventional scrap metal crusher;

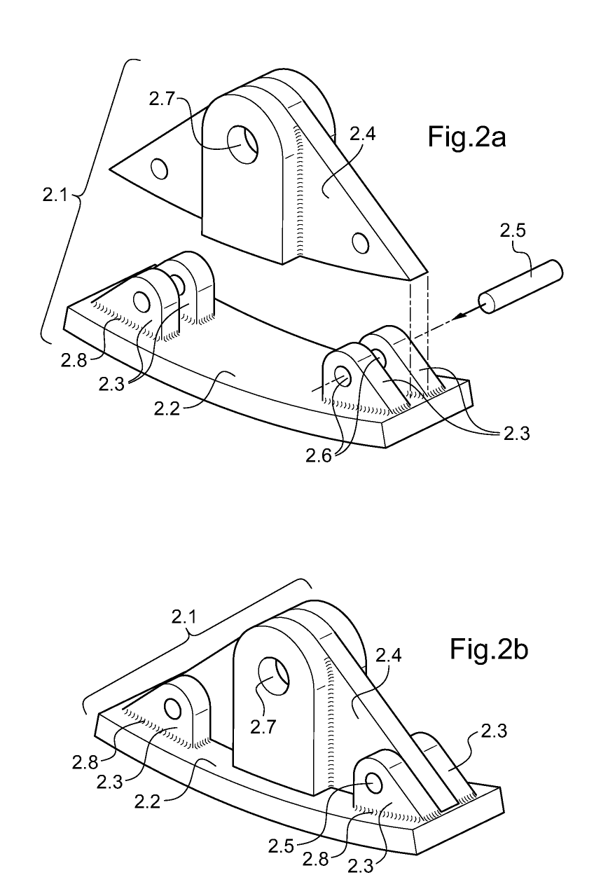

FIG. 2 represents a three-dimensional view of a first embodiment of a protection block according to the invention, with an exploded view of the two pieces forming the block as 2a;

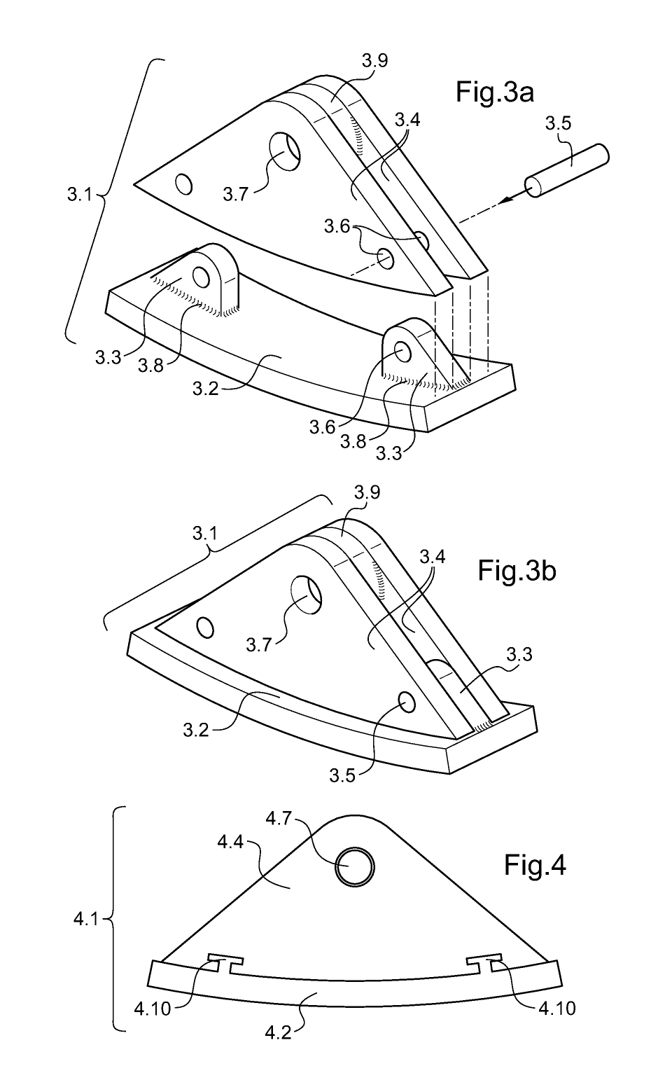

FIG. 3 represents a three-dimensional view of a second embodiment of a protection block according to the invention, with an exploded view of the two pieces forming the block as 3a;

FIG. 4 represents a profile view of a third embodiment of a protection block according to the invention.

FIG. 1 represents a cross-section of a conventional scrap metal crusher, in which the inner main casing 1, the rotor 2, the hammers 3, the anvil 4, the closed base of the casing covered with resistant armouring plates 5, the feed opening 6, the material to be crushed 7, the grid 8 provided above the rotor and the ejection door 9 are represented.

FIG. 2 represents a three-dimensional view of a protection block according to the first embodiment of the invention with an exploded view of said protection block as 2a and a view of the same protection block mounted as 2b. In this figure said protection block is shown as 2.1, with the armouring plate as 2.2, the pieces forming the first fixing means as 2.3 and the second fixing means as 2.4. 2.5 shows the shaft (or pin) which by passing through the holes 2.6 allows the armouring plate and the second fixing means to be reversibly secured. The hole 2.7, that using a shaft or pin (not shown) makes it possible to secure the protection block to the rotor of the crusher, is also shown. In this embodiment, the pieces of the first fixing means 2.3 are irreversibly secured to the armouring plate 2.2 by means of welds 2.8. Finally the difference in thickness between the centre of the second fixing means and its ends is shown.

FIG. 3 represents a three-dimensional view of a protection block according to the second embodiment of the invention with an exploded view of said protection block as 3a and a view of the same protection block mounted, as 3b. This figure shows said protection block as 3.1, with the armouring plate as 3.2, the pieces forming the first fixing means as 3.3, and the pieces forming the second fixing means as 3.4. The shaft (or pin) which by passing through the holes 3.6 allows the armouring plate and the second fixing means to be reversibly secured is shown as 3.5. The hole 3.7 which makes it possible using a shaft or pin (not shown) to secure the protection block to the rotor of the crusher is also shown. In this embodiment, the pieces of the first fixing means 3.3 are irreversibly secured to the armouring plate 3.2 by means of welds 3.8. Finally the presence of a spacer 3.9 between the 2 pieces 3.4 forming the second fixing means is shown.

FIG. 4 represents a side view of a protection block according to the third embodiment of the invention with said protection block as 4.1, the armouring plate as 4.2 and the second fixing means as 4.4. It is noted that in this configuration, the armouring plate bears at each of its ends a tenon 4.10 and that the second fixing means bears level with said tenon a mortise 4.11 having the dimensions of said tenons. Finally the presence is noted of the hole 4.7 which makes it possible using a shaft or pin (not shown) to secure the protection block to the rotor of the crusher.

1. Protection block for a rotor of a material crusher, particularly the rotors of scrap metal crushers, comprising
a first piece or armouring plate (2.2) itself comprising, detachably or non-detachably secured on its inner face, a first fixing means (2.3), and
a second piece, independent of the first piece, forming a second fixing means (2.4).

2. Protection block according to claim 1, characterized in that said armouring plate (2.2) in its orthogonal projection, has the shape of a parallelogram such as for example a rectangle, a square, a diamond.

3. Protection block according to claim 1, characterized in that said first fixing means (2.3) is in four separate pieces, positioned in pairs in order to be secured in a detachable or non-detachable manner to said armouring plate (2.2) at each end thereof.

4. Protection block according to claim 3, characterized in that at each end of said armouring plate (2.2) said 2 pieces forming the first fixing means (2.3) are positioned parallel to each other along the longitudinal axis of said armouring plate (2.2), such that between them they provide a space sufficient to receive said second fixing means (2.4).

5. Protection block according to claim 3, characterized in that each of said pieces forming said first fixing means (2.3) has substantially the shape of a right angled triangle a square or a rectangle, one side of which has a curvature allowing it to be adapted to the curvature of the inner face of said armouring plate (2.2).

6. Protection block according to claim 3, characterized in that each of said pieces forming said first fixing means (2.3) comprise at least one hole intended to be positioned level with an identical hole provided in said second fixing means (2.4) and intended to receive a shaft capable of securing the armouring plate/second fixing means assembly.

7. Protection block according claim 3, characterized in that the armouring plate/first fixing means assembly constitutes one and the same piece cast en bloc or also a single piece, the pieces forming the first fixing means (2.3) being welded onto the inner face of said armouring plate (2.2).

8. Protection block according to claim 3, characterized in that the second fixing means (2.4) in side view is substantially diamond-shaped comprising in its widest portion a first hole passing through it perpendicularly from one side to the other, said first hole being capable of receiving a shaft allowing said second fixing means (2.4) to be secured to said discs of said rotor of the crusher.

9. Protection block according claim 3, characterized in that the second fixing means (2.4) comprises at each of these ends at least one second hole passing through it perpendicularly from one side to the other, said second hole being capable of receiving a shaft allowing said second fixing means (2.4) to be secured to said armouring plate (2.2) through said second fixing means (2.4).

10. Protection block according claim 3, characterized in that said second fixing means (2.4) has in its median portion, around said first hole, a thickness substantially equal to the distance separating two discs of the rotor between which it must be intercalated and at the level of these ends a lesser thickness in order to provide between itself and the discs of the rotor spaces that are sufficient to allow said first fixing means (2.3) to be also inserted between the two discs of the rotor.

11. Protection block according to claim 10, characterized in that the thickness of said second fixing means (2.4) at these ends corresponds to one third of the dimension of the space situated between two discs of said rotor.

12. Protection block according to claim 3, characterized in that each of the pieces of the first fixing means (2.3) and the second fixing means (2.4) have an identical thickness corresponding to one third of the dimension of the space comprised between two discs of said rotor between which they must be inserted.

13. Protection block according to claim 1, characterized in that the armouring plate (2.2) bears a first fixing means (2.3) formed of two pieces, each positioned at one end of the inner face of said armouring plate (2.2).

14. Protection block according to claim 13, characterized in that each of said pieces forming said first fixing means (2.3) has substantially the form of a right angled triangle, a square or a rectangle, one of the sides of said piece having a curvature allowing it to be adapted to the curvature of the inner face of said armouring plate (2.2).

15. Protection block according to claim 14, characterized in that each of said pieces forming said first fixing means (2.3) is positioned at one end of the inner face of the armouring plate (2.2).

16. Protection block according to claim 13, characterized in that each of said pieces forming said first fixing means (2.3) comprises at least one hole intended to be positioned level with an identical hole provided in said second fixing means (2.4) and intended to receive a shaft capable of securing the armouring plate/second fixing means assembly.

17. Protection block according claim 13, characterized in that the armouring plate/first fixing means assembly constitutes one and the same piece cast en bloc or also a single piece, the pieces forming the first fixing means (2.3) being welded onto the inner face of said armouring plate (2.2).

18. Protection block according to claim 13, characterized in that the second fixing means (2.4) is formed by the combination of two pieces which in side view are substantially diamond-shaped comprising in its widest part a first hole passing perpendicularly through it from one side to the other, said first hole capable of receiving a shaft allowing said second fixing means (2.4) to be secured to said discs of said rotor of the crusher.

19. Protection block according to claim 18, characterized in that the two pieces forming the second fixing means (2.4) are positioned parallel to each other providing between them a space intended to receive the pieces forming the first fixing means (2.3).

20. Protection block according to claim 19, characterized in that the two pieces forming said second fixing means (2.4) are joined in the middle by a spacer.

21. Protection block according to claim 20, characterized in that the second fixing means (2.4) is formed in a single piece, or two separate pieces or three separate pieces.

22. Protection block according to claim 1, characterized in that the armouring plate (2.2) and the second fixing means (2.4) are secured by means of a simple tenon/mortise joint.

23. Protection block according to claim 1, characterized in that said armouring plate (2.2), the first (2.3) and the second fixing means (2.4) are produced of the same material or different materials, advantageously of the same material.

24. Protection block according to claim 23, characterized in that said material is chosen from cast manganese steel or chrome vanadium steel or antiabrasion welded machine steel.

25. Protective armouring of the rotor of a material crusher, preferably of scrap metal crushers, comprising at least one protection block such as described in claim 1.

26. Use of at least one protection block such as described in claim 1, for producing a protective armouring for the rotor of a material crusher, preferably scrap metal crushers.

27. Material crusher, particularly a scrap metal crusher, comprising a protective armouring of the rotor comprising at least one protection block such as described in claim 1.
